(19) United States
(12) Patent Application Publication
(10) Pub. No.: US 2016/0280131 A1
(43) Pub. Date: Sep. 29, 2016

(54) CONNECTED VEHICLE SYSTEM

(71) Applicant: Caruma Technologies, Inc., San Francisco, CA (US)

(72) Inventor: Christopher Warren Carson, JR., San Francisco, CA (US)

(21) Appl. No.: 15/081,481

(22) Filed: Mar. 25, 2016

Related U.S. Application Data
(60) Provisional application No. 62/139,325, filed on Mar. 27, 2015.

(51) Int. Cl. B60Q 9/00; B60R 1/00

(52) U.S. Cl. CPC B60Q 9/00; B60R 1/00

(57) ABSTRACT

Embodiments relate to operating a connected vehicle device to reduce the power consumption of the connected vehicle device to allow a battery of the connected vehicle device to maintain its charge for a longer amount of time. An amount of acceleration is sensed using one or more sensors attached to a vehicle. An event is detected by determining whether the sensed acceleration is larger than a threshold value. Responsive to an event being detected, one or more additional sensors attached to the vehicle are enabled and additional parameters are sensed using the one or more additional sensors. A determination is made whether the event is a reportable event based on the sensed additional parameters. If the event is a reportable event, a video is captured using one or more imaging devices, and the captured video is transmitted to a remote server using a cellular data network connection.

### CROSS REFERENCE TO RELATED APPLICATIONS

This application claims the benefit of U.S. Provisional Application No. 62/139,325, filed Mar. 27, 2015, which is incorporated by reference in its entirety.

### BACKGROUND

1. Field of the Disclosure

The present disclosure relates to a connected vehicle system and more specifically to notifying a user of a reportable event occurring inside or outside a vehicle.

2. Description of the Related Art

A connected vehicle system enables a user to collect and share data about the environment the vehicle and/or passenger(s) are currently in. For example, a user using a connected vehicle device may capture information such as current traffic conditions or presence of road hazards. The connected vehicle device may then share the captured information with the connected vehicle system. As such, a user of the connected vehicle system can plan a trip route based on traffic information received from other users. Similarly, other users may be able to plan their trip routes based on traffic information captured by the user of the connected vehicle system.

Current connected vehicle devices can capture data while the vehicle is in use, but many events may also happen while the vehicle is not in use (e.g., while the vehicle is parked). For instance, a second vehicle trying to park behind a first vehicle may hit the first vehicle. In another example, an unauthorized person may attempt to enter the vehicle to steal the vehicle or any items inside the vehicle. An owner of a vehicle may want to be able to record data related to those events. For instance, an owner of a first vehicle may want to be able to capture a video of the second vehicle that hit the first vehicle.

While the vehicle is not in use, the connected vehicle device may not receive power directly from the vehicle for powering the components of the connected vehicle device. In this scenario, an internal battery may be used to power the connected vehicle device, but in some occasions, a vehicle may be parked for a prolonged amount of time. As such, the battery powering the connected vehicle device may be depleted before the vehicle is turned on and power is supplied to the connected vehicle device. If an event occurs after the battery has been depleted, information related to the event will not be captured and stored by the connected vehicle device.

### SUMMARY

Embodiments relate to operating a connected vehicle device to reduce the power consumption of the connected vehicle device to allow a battery of the connected vehicle device to last for a longer amount of time. An amount of acceleration is sensed using one or more sensors in the connected vehicle device or attached to a vehicle. An event is detected by determining whether the sensed acceleration is larger than a threshold value. Responsive to an event being detected, one or more additional sensors attached to the vehicle are enabled and additional parameters are sensed using the one or more additional sensors. A determination is made whether the event is a reportable event based on the sensed additional parameters. If the event is a reportable event, a video or image is captured using one or more imaging devices, and the captured video or image is transmitted to a remote server using a cellular data network connection.

In one embodiment, the additional parameter is a picture of a surrounding area of the vehicle. In this embodiment, the determination whether the event is a reportable event includes determining whether the picture includes one of an unrecognized person within a threshold distance of the vehicle, a towing vehicle in front or behind the vehicle, and a second vehicle moving away from the vehicle.

### BRIEF DESCRIPTION OF THE DRAWINGS

The teachings of the embodiments can be readily understood by considering the following detailed description in conjunction with the accompanying drawings.

FIG. 1A is an angle view of a connected vehicle device, according to one embodiment.

FIG. 1B is a front view of a connected vehicle device, according to one embodiment.

FIG. 2 illustrates a connected vehicle device attached to a windshield mount, according to one embodiment.

FIG. 3 illustrates a block diagram of a connected vehicle device, according to one embodiment.

FIG. 4 illustrates a flow diagram of a process for switching between low power more and normal power mode, according to one embodiment.

FIG. 5 illustrates a flow diagram of a process for notifying a user of a reportable event happening in a vehicle, according to one embodiment.

FIG. 6 illustrates user interfaces of a mobile phone application notifying a user of a reportable event happening in a vehicle, according to one embodiment.

FIG. 7 illustrates user interfaces for viewing a history of reportable events, according to one embodiment.

### DETAILED DESCRIPTION

The Figures (FIG.) and the following description relate to preferred embodiments by way of illustration only. It should be noted that from the following discussion, alternative embodiments of the structures and methods disclosed herein will be readily recognized as viable alternatives that may be employed without departing from the principles of the embodiments.

Reference will now be made in detail to several embodiments, examples of which are illustrated in the accompanying figures. It is noted that wherever practicable, similar or like reference numbers may be used in the figures and may indicate similar or like functionality. The figures depict embodiments for purposes of illustration only.

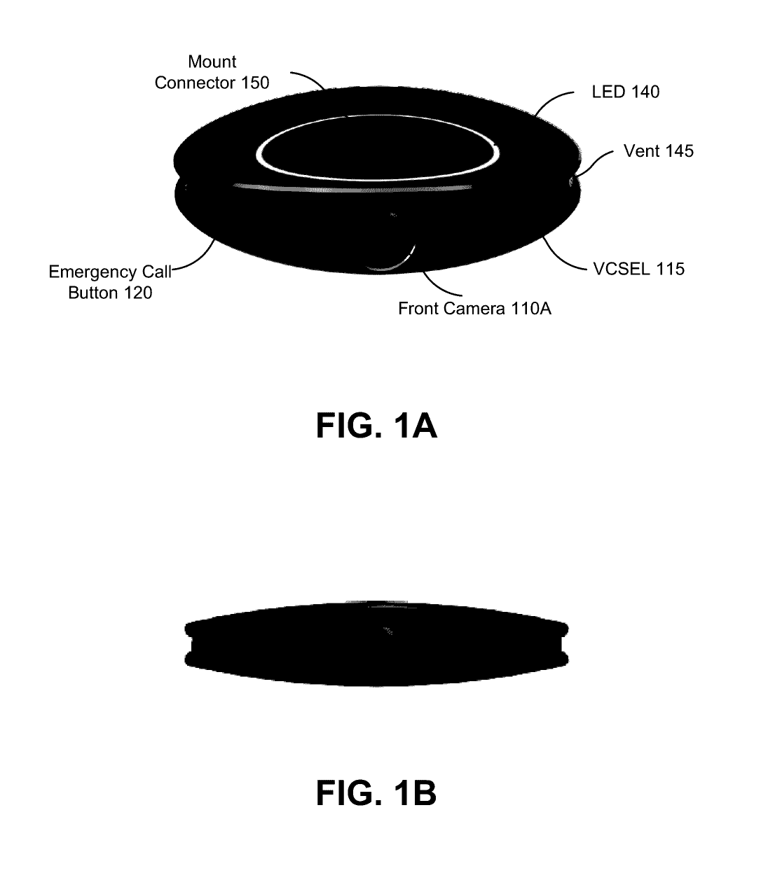

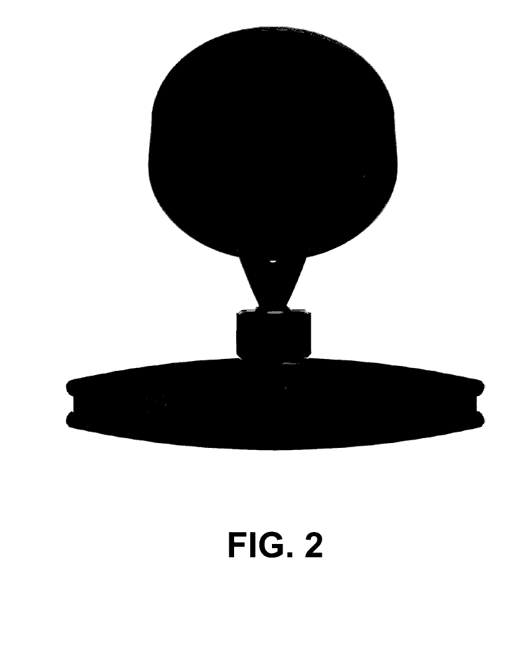

FIG. 1A is an angle view of a connected vehicle device 100, and FIG. 1B is a front view of the connected vehicle device 100, according to one embodiment. FIG. 2 is a front view of the connected vehicle device 100 coupled to a windshield mount, according to one embodiment. The connected vehicle device includes multiple cameras 110 (e.g., a front camera 100A and a rear camera), a vertical-cavity surface-emitting laser (VCSEL) unit 115, an emergency call button 120, one or more speakers (not shown), storage media (not shown), a power port (not shown), an LED 140, one or more vents 145, and a mount connector 150.

The multiple cameras 110 of the connected vehicle device 100 may include a front camera 110A and a rear camera 110B (not shown). The front camera may capture images and record videos of events occurring inside the vehicle, as well as in the back and sides of the outside of the vehicle. The rear camera may capture images and record videos of events occurring in front of the vehicle. In some embodiments, the connected vehicle device 100 may have additional cameras, or the cameras may be positioned in a different configuration. For instance, the connected vehicle device may include a rear camera to capture images and record vides of event occurring in front of the vehicle, a front camera to capture images and record videos of event occurring in the back of the vehicle, and two side cameras to capture images and record videos of events occurring in either side of the vehicle. In some embodiments, cameras 110 may further be able to determine a distance between the connected vehicle device and objects in the field of view of the cameras 110. For instance, a depth of field (DOF) of a camera may be used to determine how far away from the camera an object is.

The VCSEL unit 115 detect hand gestures for controlling the connected vehicle device 100. For instance, a user may instruct the connected vehicle device 100 to capture a video and store the video using the front and rear cameras 110 of the connected vehicle device 100. To detect the hand gestures, the VCSEL unit 115 projects a field of energy, such as coherent light pattern, and detects any distortions of the light pattern. In some embodiments, a single VCSEL is used to generate the field of energy. In other embodiments, an array of multiple VCSELs are used. Different hand gestures may be detected for different distortion patterns of the coherent light pattern. In some embodiments, the coherent light pattern is a two-dimensional dot pattern. In other embodiments, the coherent light pattern is a two-dimensional mesh. In some embodiments, the VCSEL unit 115 includes a detector to sense the field of energy projected by the VCSEL unit 115. In some embodiments, the VCSEL unit 115 detects changes in the sensed field of energy to identify hand gestures for controlling the connected vehicle device. In other embodiments, the VCSEL unit 115 compares the sensed field of energy with an expected pattern to identify the hand gestures.

The emergency button 120 allows the user to call an emergency response dispatch system. For instance, in the United States, the emergency button 120 may call 9-1-1, or in Europe, the emergency button 120 may call 1-1-2. In other embodiments, the emergency button allows the user to call a private emergency response monitoring service. The monitoring system may determine, based on data received from the connected vehicle device, the type of emergency, and an appropriate action for addressing the emergency. In yet other embodiments, the emergency button 120 calls a user's emergency contact (e.g., an emergency contact listed in the user's phone). In yet other embodiments, the connected vehicle device may determine the type of emergency based on data captured by a number of sensors, and calls a different number for different types of emergencies. For instance, if the connected vehicle device 100 determines that the emergency is a collision, the connected vehicle device 100 calls an emergency response dispatch system or a monitoring service. In another example, if the connected vehicle device 100 determines that the emergency is a vehicle malfunction, the connected vehicle device 100 calls a roadside assistance service.

The speakers provide audible cues and feedback to the user. For instance, the speakers may provide audible feedback in response to commands provided to the connected vehicle device 100. The speakers may also be used to play an alarm in the event of an emergency. For instance, the speakers may play a loud high pitch alarm if the connected vehicle system 100 determines that a person is trying to break into the vehicle. Furthermore, the speakers may be used to establish a two way call with the connected vehicle system, e.g., for providing verbal assistance or mentoring to the driver of the vehicle.

The storage media locally stores the data generated by the connected vehicle device 100. For instance, the storage media locally stores the pictures and videos captured by the cameras 110. The storage media may further locally store vehicle dynamic information such as position data, velocity data, and acceleration data associated with the image. In some embodiments, the storage device includes removable and non-removable storage media. The non-removable storage media may store data and instructions for operating the connected vehicle device 100 (e.g., settings data and operating system of the connected vehicle device 100) and local applications to be executed by the connected vehicle device 100. The removable storage media may store data captured by the multiple cameras and the different sensors included in the connected vehicle device 100.

The power port provides a connection between the connected vehicle device 100 and a DC power outlet of a vehicle. Electrical power is provided to the connected vehicle device 100 through the power port for operating the connected vehicle device 100 and charging a battery disposed inside the connected vehicle device 100.

The LED 140 provides visual feedback to the driver or to users nearby the connected vehicle device 100. For instance, while the driver of a vehicle is operating the vehicle, the LED 140 may provide visual feedback of the efficiency of the driver's driving style. In another example, while the vehicle is parked, the LED 140 may provide a visual feedback to people passing by the vehicle that an alarm system is armed, and if the alarm system is triggered, the LED 140 additionally provide a visual feedback indicating so. In some embodiments, the color of the LED changes based on the quality of the driver's driving.

The one or more vents 145 provide air ventilation to the internal components of the connected vehicle device 100. In some embodiments, the connected vehicle device 100 may additional include one or more fans to circulate air inside a housing of the connected vehicle device 100.

The mount connector 150 couples the connected vehicle device 100 to a windshield mount, a rearview mirror, or a dashboard mount. For instance, in the view of FIG. 2, the connected vehicle device 100 is coupled to a windshield mount.

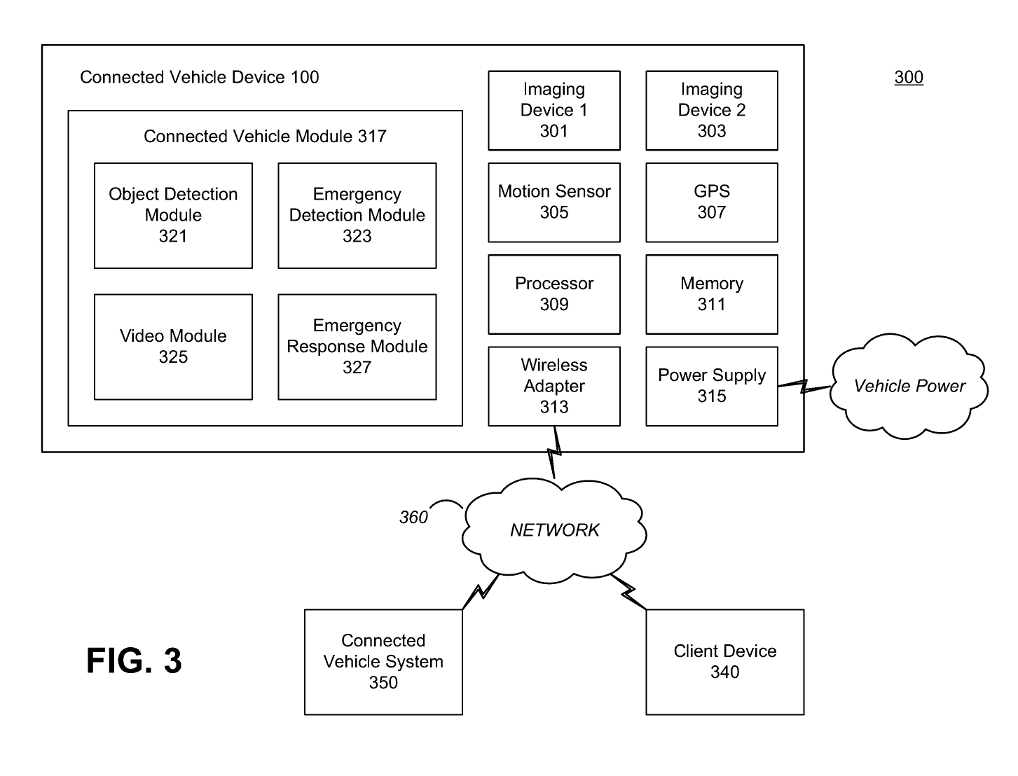

FIG. 3 is a block diagram illustrating a system architecture 300, according to one embodiment. The system architecture 300 includes the connected vehicle device 100, a connected vehicle system 350, a client device 340, and a network 360.

The connected device, such as the connected vehicle device 100 of FIG. 1A, includes imaging device 301 (such as front camera 100A), imaging device 303 (such as rear camera 100B), motion sensor 305, Global Navigation Satellite System (GNSS) receiver 307, processor 309, memory 311, wireless adapter 313, power supply 315, and connected vehicle module 317.

As described in conjunction with FIG. 1A, imaging devices 301 and 303 capture images and videos of the surroundings of a vehicle as well as inside the vehicle. Imaging devices 301 and 303 may include a complementary metal-oxide-semiconductor (CMOS) based image sensor, or a charged coupled device (CCD) based image sensor. Imaging devices 301 and 303 may further include lenses that focus the light that is incident to the image sensors. In some embodiment, the imaging devices 301 and 303 include wide angle lenses. For instance, imaging devices 301 and 303 each includes a lens array that allows for a field of view of 180°. In other embodiments, a larger number of imaging devices, each having a smaller field of view may be used. For instance, 3 imaging devices, each having a 120° field of view may be used to achieve an aggregate field of view of about 360°.

The motion sensor 305 senses vibrations and accelerations experienced by the connected vehicle device 100. The motion sensor 305 may include single or multiple axis accelerometers. For instance, the motion sensor 305 may include a three axis accelerometer for measuring the accelerations in the longitudinal, sagittal, and transversal axis of the vehicle. The motions sensor 305 may include additional sensors such as gyroscopes (such as a three-axis MEMS-based gyroscope) to sense the extent and the rate of rotation in space (roll, pitch, and yaw). The data captured by the motion sensor 305 may be used, for example, to assess the vehicle's driver's driving efficiency while the driver is operating the vehicle. To assess the efficiency of the driver, the connected vehicle device 100 may determine a score based on the magnitude of the acceleration captured by the motion sensor 305. In another example, the data captured by the motion sensor 305 may be used to determine whether an event has occurred while the vehicle is parked. Details of this feature are explained in conjunction with FIG. 5. In some embodiments, data captured by the motion sensor 305 is used in conjunction with data captured by other sensors. For instance, data captured by the motion sensor 305 may be used in conjunction with videos or images captured by cameras 110 to determine is the driver of the vehicle is intoxicated or falling asleep.

The connected vehicle device 100 may include additional sensors such as a light sensor, a microphone, an altitude sensor, a compass, a temperature sensor, a pressure sensor, a carbon monoxide sensor, air pollution sensor, proximity sensor and/or a humidity sensor. Each sensor is used to gather additional data regarding events occurring inside and around the perimeter of the vehicle. In some embodiments, the connected vehicle device 100 may include a connection port for allowing the connection of additional external sensors. In other embodiments, external sensors may be wirelessly connected to the connected vehicle device 100. For instance, an on-board diagnostics (ODB) device may be connected to connected vehicle device 100 to receive data from an electronic control unit (ECU) of the vehicle.

The Global Navigation Satellite System (GNSS) receiver 307 calculates the geographical location of the connected vehicle device by receiving information from multiple GNSS satellites. In some embodiments, the GNSS receiver 307 is capable of receiving information from one or more of a Global Positioning System (GPS) satellite, a Global Navigation Satellite System (GLONASS) satellite, a Galileo satellite, or any other GNSS satellite. The GNSS 307 may be used, for example, to send an emergency response team to the location of the vehicle if an emergency is detected by the connected vehicle system.

The processor 309 may, for example, be one of a central processing unit (CPU), a graphics processing unit (GPU), a digital signal processor (DSP), one or more application specific integrated circuits (ASICs), one or more radio-frequency integrated circuits (RFICs), or any combination thereof. The processor 309 executes instructions residing in memory 311. The processor 309 may also send instructions to other components of the connected vehicle device 100. For instance, the processor 309 may send instructions to the imaging devices 301, 302 to start recording a video.

The wireless adapter 313 links the connected vehicle device 100 via a network to the connected vehicle system 350 and to one or more client devices 340. The wireless adapter provides the functionality of receiving and routing messages between the connected vehicle device 100 and the connected vehicle system 350. In some embodiments, the connected vehicle device 100 connects to the network via a cellular network (e.g., using 3G, 4G, or any other type of mobile telecommunications technology). The connected vehicle device 100 may further include short distance wireless transceivers, such as one or more of Bluetooth, Bluetooth Low Energy (BLE), WiFi, ZigBee, EnOcean, personal area networks, TransferJet, dynamic host configuration protocol (DHCP), and ultra-wideband (UWB). The connected vehicle device 100 uses the short distance wireless transceiver to communicate with a client device 340 while the client device is in close proximity to the connected vehicle device 100.

The power supply 315 provides electrical power to drive the components of the connected vehicle device 100. The power supply 315 may receive electrical power from the vehicle through the vehicle's DC power outlet. In some embodiments, the power supply 315 includes a DC-to-DC converter for downscaling the voltage supplied by the vehicle's DC power outlet. The power supply 315 further includes a battery for powering components of the connected vehicle device 100 while not receiving power form the vehicle's DC power outlet. The power supply 315 may further include circuitry for charging the battery when receiving power from the vehicle's DC power outlet.

The connected vehicle module 317 identifies reportable events. As used herein, a reportable event is an event to be reported by the connected vehicle module 317 to the connected vehicle system 350. For instance, a reportable event may be a collision of the vehicle, a person trying to break in the vehicle, or the vehicle being towed. The connected vehicle module 317 includes an object detection module 321, an emergency detection module 323, a video module 325, and an emergency response module 327.

The object detection module 321 detects different objects present in an image or a video captured by imaging devices 301 and 303. In some embodiments, the object detection module 321 detects objects using computer vision algorithms and machine learning algorithms to analyze patterns and detect objects in a captured image. In some embodiments, the object detection module 321 detects the different objects present in an image or a video using a computing module of the connected vehicle device 100 (e.g., processor 309). In other embodiments, the object detection module 321 uses a computing module located in a remote system (e.g., by the connected vehicle device).

The reportable event detection module 323 detects different events and determines whether an events is a reportable event. In some embodiments, the reportable event detection module 323 detects events using images captured by imaging device 301 and/or imaging device 303. For instance, the reportable event detection module 323 detects events where a newly captured image and a previously captured image differ by more than a threshold amount (e.g., the detection of motion in a stream of images). In other embodiments, the reportable event detection module 323 detects events using data from the motion sensor 305. For instance, the reportable event detection module 323 detects events where the acceleration sensed by an accelerometer of the motion sensor 305 is greater than a threshold. Using data from the motion sensor 305 to detect events allows the connected vehicle device 100 to save energy (e.g., when not receiving power from the vehicle's power source, e.g., vehicle's battery), while allowing the reportable event detection module to analyze a continuous stream of data.

The reportable event detection module 323 further determines whether an event is a reportable event. As disclosed herein, a reportable event is an event that is reported to the connected vehicle system 350. In some embodiments, the user may select the types of events that are to be reported to the user. In other embodiments, the connected vehicle device 100 reports every reportable event from a predetermined list of reportable events. In some embodiments, to determine whether an event is a reportable event, after an event has been detected, the connected vehicle device 100 activates every available sensor (e.g., motion sensor 305, imaging devices 301 and 303, GNSS 307, microphones, light sensors, etc.), or a subset of sensors that are disabled while the connected vehicle device is operating in low power mode 415.

In one embodiment, to determine whether an event is a detectable event, the reportable event detection module 323 may use a microphone to determine whether a vehicle alarm has been triggered, whether a window of the vehicle has been broken, or whether the engine of the vehicle has been turned on. In another embodiment, the reportable event detection module uses images or videos captured by imaging devices 301 and 303 to determine whether an unrecognized person is attempting to enter the vehicle, whether an unrecognized person has entered the vehicle, or whether the vehicle's lights are flashing. In yet another example, pressure sensor data may be used to determine whether a window has been broken, or may use proximity sensor data de determine whether a person has approached the vehicle or whether a person has entered the vehicle. In some embodiments, the connected vehicle device 100 uses data received from the on-board diagnostics (ODB) port of the vehicle to determine whether an event is a reportable event. For example, the connected vehicle device 100 may use data received from the ODB port to determine whether a door of the vehicle has been opened or whether a turn signal has been turned on.

The video module 325 captures videos using imaging devices 301 and 303 and stores the videos in the storage media. The video module 325 further transmits captured videos or images (e.g., video frames of a recorded video) when a reportable event is detected. For instance, the video module 325 transmits a 30 second video captured before and/or after a reportable event has been detected. In some embodiments, the video module uses a flexible rate control to dynamically change the bit rate and frame rate of videos captured (e.g., based on a bandwidth of a wireless network connection, or an amount of charge remaining in an internal battery of the connected vehicle device 100).

The reportable event response module 327 transmits a message to the connected vehicle system 350 responsive to a detectable event having been detected. In some embodiments, the reportable event response module 327 may play an alarm sound (e.g., a loud and high pitched alarm). The reportable event response module 327 may further illuminate the cabin using LED 140. In some embodiments, the reportable event response module 327 may further control the vehicle (e.g., through the ODB port of the vehicle). For instance, the reportable event response module 327 may disable the vehicle if the engine has been turned on, may flash the vehicle's lights, or may start the vehicle's alarm.

The connected vehicle system 350 receives and stores data captured by the connected vehicle device 100, analyzes the received data, and performs different actions based upon the outcome of the analysis of the data received from the connected vehicle device 100. For instance, the connected vehicle system 100 may notify an emergency contact of a user of a connected vehicle device 100 if the connected vehicle system 100 determines that the user has been involved in a vehicle collision. In some embodiments, the connected vehicle system includes a computer processor and a storage medium for executing algorithms for analyzing the data from the vehicle.

The client device 340 is used by a user for interacting with the connected vehicle device 100 and the connected vehicle system 350. The client device 340 can be a personal computer (PC), a desktop computer, a laptop computer, a notebook, a tablet PC. In another embodiment, the client device 340 can be any device having computer functionality, such as a personal digital assistant (PDA), mobile telephone, smartphone, smartwatch, etc.

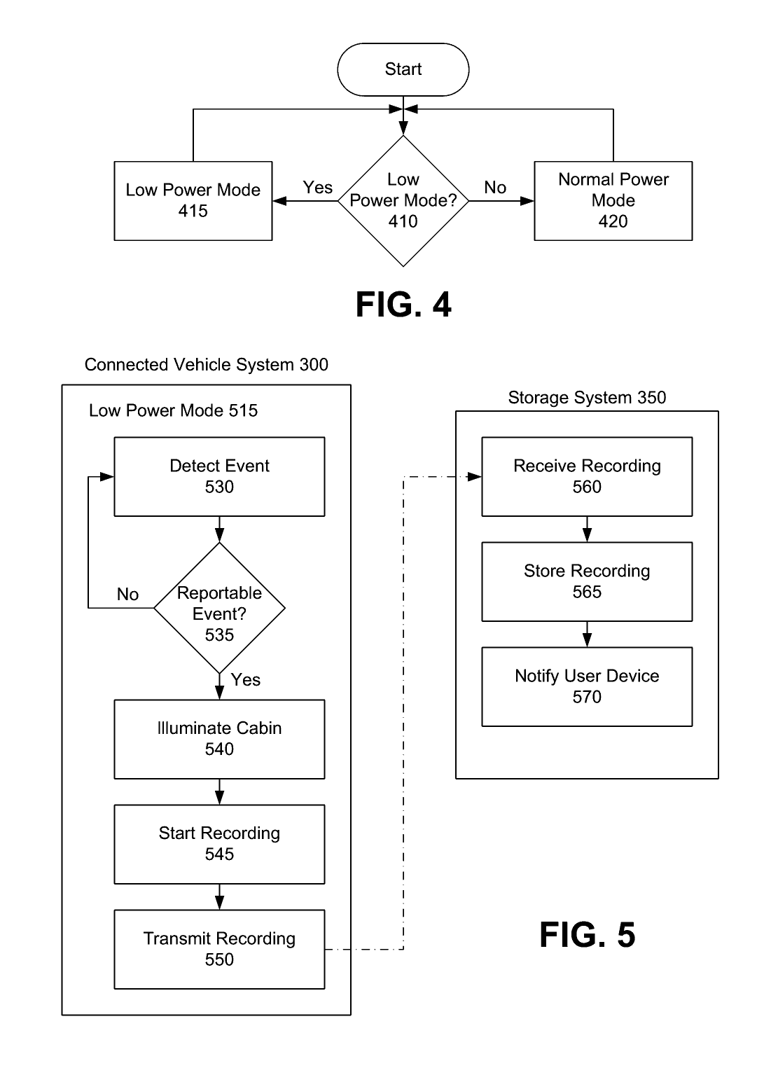

FIG. 4 illustrates a flow diagram of a process for switching between normal power more and low power mode, according to one embodiment. The connected vehicle may transition between normal power mode 420 and low power mode 415 to save energy. The process makes a determination whether to be in low power mode. If a determination is made 410 to be in low power mode and the connected vehicle device 100 is in normal power mode, the connected vehicle device switches from normal power mode to low power mode 415. Otherwise if a determination is made not to be in low power mode and the connected vehicle device 100 is in low power mode, the connected vehicle device 100 switches from low power mode to normal power mode 420.

To make the determination whether to be in low power mode in step 410, the connected vehicle device may use different signals. In one example, the connected vehicle device 100 determines to be in low power mode if the connected vehicle device 100 is not receiving power from the vehicle's DC power outlet. Certain vehicles provide power from the DC power outlet even when the engine of the car is off. Thus, if a connected vehicle device 100 uses the power being received from the vehicle as a signal to switch to low power mode, the connected vehicle device 100 may not switch to low power mode until a battery of the car has lost its charge. As a result, when the user comes back to the vehicle, the user may have trouble starting the engine of the vehicle. In another example, the connected vehicle device 100 determines 410 that it will be in low power mode 415 if a mobile phone of a user is not connected to the connected vehicle device 100 (e.g., via Bluetooth, Bluetooth Low Energy BLE, etc.), and determines 410 it will be in normal power mode 420 if a mobile phone of the user is connected to the connected vehicle device 100. Furthermore, the connected vehicle device 100 may identify whether a known person is within the field of view of a camera 110. For instance, the connected vehicle device 100 may use a facial recognition algorithm to match a face of a person captured by a camera 110 with the face of one or more people associated with the connected vehicle device 100. If a known person is not recognized, the connected vehicle device 100 may determine 410 that it will be in low power mode 415.

In the low power mode 415, the connected vehicle device turns off a subset of components to save energy to allow the energy stored in the battery last for a longer period of time. For instance, in the low power mode 415, the connected vehicle device 100 turns off the imaging devices 301 and 303. The connected vehicle device 100 may further lower the performance of the processor 309 and/or memory 311 to further lower the power consumption. The connected vehicle device 100 may further disable a cellular connectivity and/or other types of long range wireless transceivers. When an event is detected by the reportable event detection module 323, the connected vehicle device 100 may turn on the components that were turned off. As such, the connected vehicle device 100 may gather additional data regarding the detected event.

FIG. 5 illustrates a flow diagram of a process for notifying a user of a reportable event happening in a vehicle, according to one embodiment. The reportable event detection module 323 detects 530 an event. For instance, the reportable event detection module 323 detects and event where the accelerations sensed by motion sensor 305 is greater than a threshold value. Upon detecting the event, the reportable event detection module 323 determines 535 whether the event is a reportable event. If the event is not a reportable event, the process returns to step 530. Otherwise, if the event is a reportable event, the reportable event response module 327 illuminates 540 the cabin of the vehicle, the video module starts capturing 545 videos using imaging devices 301 and 303, and recorder videos are transmitted 550 to the connected vehicle system 350. In some embodiments, if the cellular connectivity of the connected vehicle device is disabled, prior to transmitting 550 the recorded videos to the connected vehicle system 350, the cellular connectivity of the connected vehicle device is enabled. In some embodiments, the reportable event response module 527 may perform additional steps, as described hereinabove, upon determining that an event is a reportable event. In one embodiment, the reportable event response module 327 only illuminates the cabin if the lighting level inside the cabin of the vehicle is below a threshold.

Referring back to FIG. 5, the connected vehicle system 350 receives 560 the video captured by the video module and stores 565 the video. The connected vehicle system 350 further notifies the client device 340 associated with the connected vehicle device 100 of the reportable event.

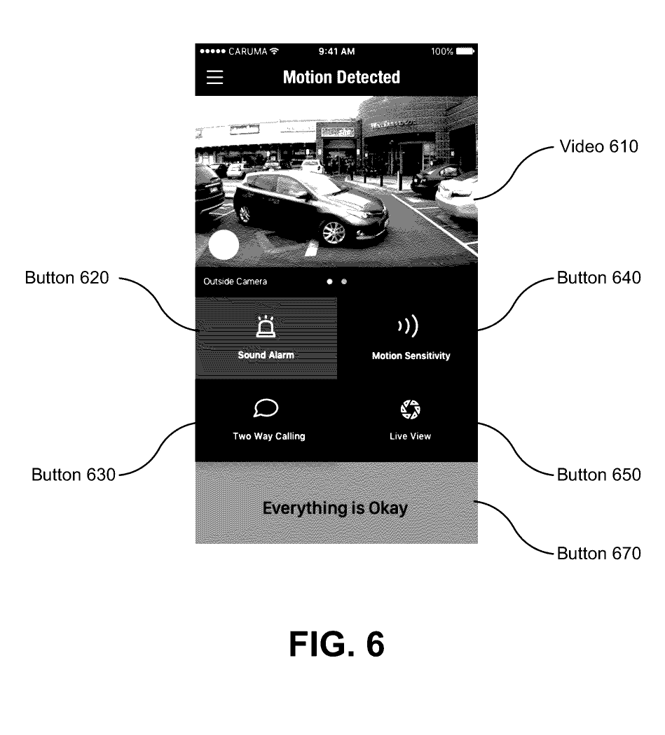

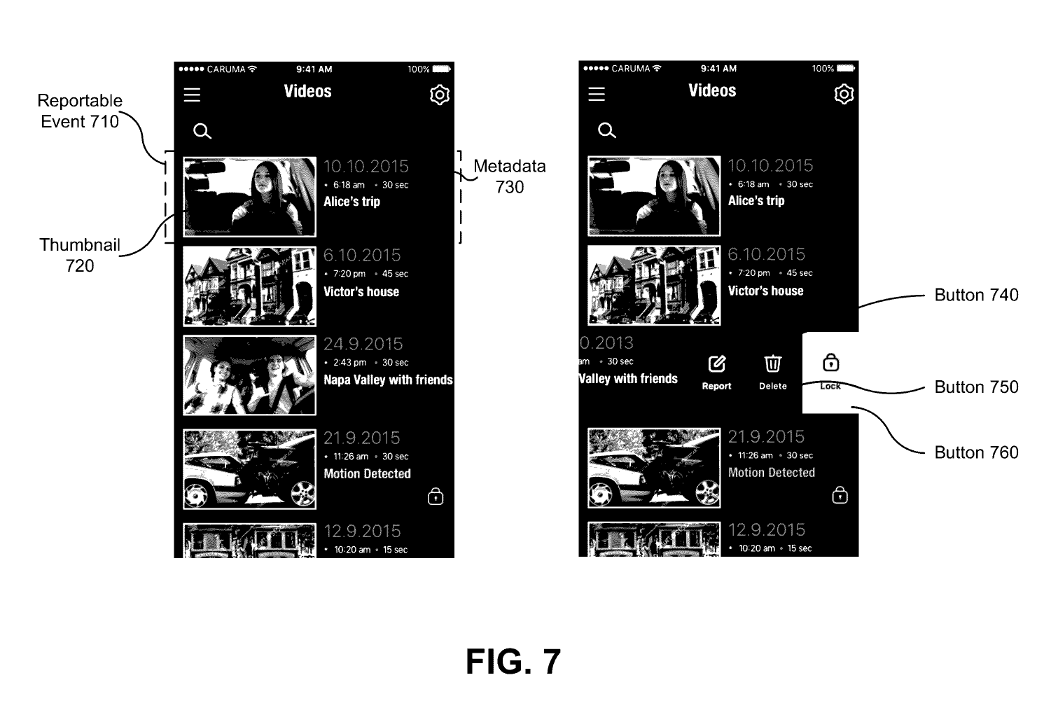

After the client device 340 has been notified, the user may access the details of the reportable event through the client device 340, and may perform different actions. For instance, the user may start an alarm to scare away a person trying to break into the vehicle. In another example, a user may instruct the connected vehicle system to transfer the captured information about a reportable event to the user's insurance company and start a claim (e.g., in response to the user's vehicle having been hit by other vehicle). A more detailed description of different actions that the user may take for a reportable event is included hereinbelow in conjunction with FIGS. 6 and 7.

FIG. 6 illustrates user interfaces of a mobile phone application notifying a user of a reportable event happening in a vehicle, according to one embodiment. The user interface 600 includes a video 610 of the reportable event, a button 620 for activating an alarm, a button 630 for making a two way call with the connected vehicle device 100, a button 640 for changing the sensitivity of the connected vehicle device 100, a button 650 for viewing a live video being captured by the imaging devices of the connected vehicle device 100, and a button 670 for disregarding the reportable event.

Video 610 of the reportable event is a video captured by the imaging devices of the connected vehicle device 100 in response to a reportable event being detected. In some embodiments, the connected vehicle device 100 captures a video of a predetermined length (e.g., 30 sec). The user interface element 610 for viewing the video may allow the user to switch between a video recorded by the front camera and the video captured by the rear camera of the connected vehicle device 100.

Button 620 for activating the alarm is a user interface element that allows the user to activate the alarm sound of the connected vehicle device 100 or of the vehicle itself. That is, pressing the button 620 for activating the alarm causes the speakers to connected vehicle device 100 to play a loud and high pitched alarm sound. In some embodiments, the button 620 for activating the alarm further causes the LED of the connected vehicle device to provide visual feedback that a response team is on its way to the vehicle.

Button 630 for making a two way call with the connected vehicle device allows the user to communicate with a person that is inside the vehicle or nearby the vehicle. After the two way call is established, the user would be capable of listening to the sounds recorded by a microphone of the connected vehicle device 100 and the connected vehicle device 100 would be capable of playing sounds recorded by a microphone of the client device 340.

Button 640 for changing the sensitivity of the connected vehicle device 100 allows the user to set the sensitivity of the motion sensor of the connected vehicle device 100. For instance, changing the sensitivity of the connected vehicle device 100 changes the threshold used by the connected vehicle device 100 for detecting events. In some embodiments, the user may choose between a pre-set number of sensitivity options (e.g., low, medium, high). In other embodiments, the user may have a finer control over the sensitivity of the connected vehicle device 100. For example, a user may assign a sensitivity value between 0 and 100, where a sensitivity of 100 is higher than a sensitivity of 0.

Button 650 for viewing a live video being captured by the imaging devices of the connected vehicle device 100 allows the user to view what is currently happening in the surrounding of the vehicle. After viewing the live video, the user may have a better idea of caused the reportable event and what actions to take.

Button 670 for disregarding the reportable event notifies the connected vehicle device 100 and/or the connected vehicle system 350 that the user is aware of the reportable event and that no further action is needed. In some embodiments, the notification of the reportable event times out after a predetermined amount of time (e.g., after 4 minutes). The connected vehicle device 100 may take a default action if the notification times out. For instance, the alarm of the connected vehicle device 100 may be activated if the notification of the reportable event times out. In other embodiments, if the notification of the reportable event times out, the notification may be routed to a monitoring service that can analyze the reportable event on behalf of the user and take action if needed.

FIG. 7 illustrates user interfaces for viewing a history of reportable events. The user interface includes a list of past reportable events stored in the connected vehicle system 350, according to one embodiment. Each reportable event 710 includes a thumbnail 720 of the reportable event and metadata 710 of the reportable event. Metadata 730 may include a timestamp of the reportable event, a type of reportable event, a location of the reportable event, etc. Each reportable event may include buttons for performing actions related to the reportable event. For instance, user interface 700 includes a button 740 for reporting the reportable event, button 750 for deleting the reportable event, and button 760 for locking the reportable event.

Button 740 for reporting the reportable event allows the user to transfer information to the user's insurance company and start a claim with the insurance company or contact authorities (e.g., local law enforcement or call center). In one embodiment, pressing button 740 instructs the connected vehicle system 350 to transfer all or a subset of the data captured by the connected vehicle device 100 that is related to the reportable event being reported to the insurance company or call center or authorities. In another embodiment, pressing button 740 causes the client device 340 to transfer all or a subset of the data related to the reportable event to the insurance company or monitoring center or authorities. Pressing button 740 may further cause the connected vehicle device to transfer additional data that was not transmitted to the connected vehicle system (i.e., additional data that was not transmitted to the connected vehicle system at step 560 of FIG. 5). For instance, the connected vehicle device 100 may transmit a video that is longer or that has a higher resolution than the video that was transmitted to the connected vehicle system at step 560. Furthermore, pressing button 740 may cause the connected vehicle system 350 to transmit a document for starting the insurance claim to the client device 340, or to another location associated with a user account of the user in the connected vehicle system 350 (e.g., to an email account associated with the user account).

Button 750 for deleting the reportable event allows the user to delete the information related to the reportable event from the connected vehicle system 350. In some embodiments, button 750 may further cause data to be deleted from the connected vehicle device 100.

Button 760 for locking the reportable event allows the user to lock a reportable event to prevent the reportable event from being deleted from the connected vehicle system 350. In some embodiments certain reportable events are automatically locked. For instance, a reported collision detected by the connected vehicle device is automatically locked by the connected vehicle system 350 to prevent the reported collision from being deleted.

### ADDITIONAL CONFIGURATION CONSIDERATIONS

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of ordinary skill in the art will appreciate still additional alternative structural and functional designs through the disclosed principles of the embodiments. Thus, while particular embodiments and applications have been illustrated and described, it is to be understood that the embodiments are not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A method for notifying a user of a reportable event occurring to a vehicle, comprising:
sensing an amount of acceleration of the vehicle using one or more sensors attached to the vehicle;
detecting an event by determining whether the sensed acceleration is larger than a threshold value;
responsive to detecting the event:
enabling one or more additional sensors attached to the vehicle, the additional sensors different than the one or more sensors;
sensing additional parameters using the one or more additional sensors;
determining whether the event is a reportable event based on the sensed additional parameters; and
responsive to determining that the event is a reportable event:
capturing a video using one or more imaging devices; and
transmitting the video to a remote server using a cellular data network connection.

2. The method of claim 1, wherein the additional parameter is image data of a surrounding area of the vehicle, and wherein determining whether the event is a reportable event comprises:
determining whether the image data includes one of an unrecognized person within a threshold distance of the vehicle, a towing vehicle in front or behind the vehicle, and a second vehicle moving away from the vehicle.

3. The method of claim 1, wherein the vehicle is not occupied.

4. The method of claim 1, wherein the vehicle is stationary prior to detected acceleration

5. A method for notifying a user of a reportable event occurring to a vehicle, comprising:
sensing a first parameter of the vehicle using one or more sensors attached to the vehicle;
detecting an event using the sensed first parameter;
sensing a second parameter using one or more additional sensors attached to the vehicle;
determining whether the event is a reportable event based on the sensed second parameter and the first sensed parameter; and
responsive to determining that the event is a reportable event:
capturing a video using one or more imaging devices, and
transmitting the video to a remote server.

6. The method of claim 5, wherein the first parameter is an amount of acceleration sensed by an accelerometer attached to the vehicle, and wherein detecting the event comprises determining whether the amount of acceleration sensed by the accelerometer is larger than a threshold value.

7. The method of claim 5, wherein sensing a second parameter using one or more additional sensors attached to the vehicle comprises capturing an image using an imaging device; and wherein determining whether the event is a reportable event comprises determining whether the captured image includes an unrecognized person.

8. The method of claim 5, wherein sensing a second parameter using one or more additional sensors attached to the vehicle comprises capturing an audio recording using a microphone; and wherein determining whether the event is a reportable event comprises determining whether the captured audio includes an engine sound.

9. The method of claim 5, wherein sensing a second parameter using one or more additional sensors attached to the vehicle comprises capturing a position data using a global navigation satellite system (GNSS) receiver; and wherein determining whether the event is a reportable event comprises determining whether the position data has changed.

10. The method of claim 5, further comprising, responsive to determining that the event is a reportable event:
enabling a cellular data connectivity; and
connecting to a cell tower using the enabled cellular data connectivity.

11. The method of claim 5, wherein the vehicle is not occupied.

12. The method of claim 5, wherein the vehicle is stationary prior to detected acceleration.

13. A non-transitory computer readable storage medium storing instructions, the instructions when executed by a processor cause the processor to:
sense a first parameter of the vehicle using one or more sensors attached to the vehicle;
detect an event using the sensed first parameter;
sense a second parameter using one or more additional sensors attached to the vehicle;
determine whether the event is a reportable event based in the sensed second parameter and the first sensed parameter; and
responsive to determining that the event is a reportable event:
capture a video using one or more imaging devices, and
transmit the video to a remote server.

14. The non-transitory computer readable storage medium of claim 13, wherein the first parameter is an amount of acceleration sensed by an accelerometer attached to the vehicle, and wherein detecting the event comprises determining whether the amount of acceleration sensed by the accelerometer is larger than a threshold value.

15. The non-transitory computer readable storage medium of claim 13, wherein sensing a second parameter using one or more additional sensors attached to the vehicle comprises capturing an image using an imaging device; and wherein determining whether the event is a reportable event comprises determining whether the captured image includes an unrecognized person.

16. The non-transitory computer readable storage medium of claim 13, wherein sensing a second parameter using one or more additional sensors attached to the vehicle comprises capturing an audio recording using a microphone; and wherein determining whether the event is a reportable event comprises determining whether the captured audio includes an engine sound.

17. The non-transitory computer readable storage medium of claim 13, wherein sensing a second parameter using one or more additional sensors attached to the vehicle comprises capturing a position data using a global navigation satellite system (GNSS) receiver; and wherein determining whether the event is a reportable event comprises determining whether the position data has changed.

18. The non-transitory computer readable storage medium of claim 13, wherein the instructions further cause the processor to, responsive to determining that the event is a reportable event:
enable a cellular data connectivity; and
connect to a cell tower using the enabled cellular data connectivity.

19. The non-transitory computer readable storage medium of claim 13, wherein the vehicle is not occupied.

20. The non-transitory computer readable storage medium of claim 13, wherein the vehicle is stationery prior to detected acceleration.
